(19) United States
(12) Patent Application Publication
(10) Pub. No.: US 2003/0217184 A1
(43) Pub. Date: Nov. 20, 2003

(54) Method and apparatus for allocating buffers shared among protocol layers in a protocol stack

(76) Inventor: Govindan Nair, Fremont, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/752,095

(22) Filed: Dec. 30, 2000

(51) Int. Cl. G06F 15/16

(52) U.S. Cl. 709/250

(57) ABSTRACT

A data frame is received at a communications protocol software module and a memory buffer is allocated in which to store at least some portion of the data frame from a pool of available memory buffers. Depending on the processing that needs to be done by the communications protocol software module, at least some portion of the data frame is stored in the memory buffer. A pointer to the memory buffer is provided to the communications protocol software module, so that the communications protocol software module can access the data frame in the memory buffer. When the communications protocol software module is done processing the data frame, a buffer manager transfers control of processing the data frame from the communications protocol software module to a second communications protocol software module. The pointer to the memory buffer to provided to the second communications protocol software module so it can then access the data frame in the memory buffer pointed to by the pointer, and process the data frame.

### FIELD OF THE INVENTION

The present invention is relates to a method for allocating buffer space utilized by a protocol stack.

### BACKGROUND OF THE INVENTION

A machine connected to a network, such as a computer connected to the Internet, communicates with other machines in the network according to a commonly understood protocol or set of protocols, so that the machines may exchange, or aid in the exchange of, information. For example, an employee may access their company's intranet web site from an end user device, such as a personal computer, via a local area network adapter connection, or a user may access a public web site on the world wide web via a dial up modem connection. A browser application such a Microsoft Internet Explorer may provide the user services to access the website. End user devices, as well as other types of machines, such as switches, routers, gateways, or hubs, transport and route information to other machines according to a commonly understood protocol or set of protocols. These machines typically provide for end-to-end communication with other machines in accordance with a transport protocol application that provides information delivery services to aid in the exchange of information between machines in the network, such as the Transport Control Protocol (TCP). These machines also typically provide for routing of information across the internetwork to which the machines are connected in accordance with a routing protocol, such as the Internet Protocol (IP). Of course, a physical layer communication protocol provides for transmission of binary digits between the machines. It should also be appreciated that physical layer communication may take place over a wire-based communication medium, as well as, for example, a wireless radio frequency (RF) communication channel.

The protocols are often conceptually referred to as a stack of protocols, in which lower layer protocol service higher layer protocols in the stack, generally in accordance with the International Standards Organization (ISO) Open Systems Interconnection (OSI) reference model for network communication between the machines. A software module that implements at least one of the protocols is often created by one vendor, and combined to execute in a machine with other software modules that implement one or more of the other protocols in the protocol stack. These other software modules likewise may be developed by one or more different vendors.

For example, a machine may have implemented therein a protocol stack in which a driver for physical layer communications is provided from one vendor, such as an Asynchronous Transfer Mode (ATM) driver, or an IEEE std 802.3/Ethernet driver, and a network layer protocol, such as IP, is provided by a second vendor. A transport layer protocol, for example, may be provided by yet another vendor. Each software module implementing a particular layer of a protocol stack typically provides for its own buffer space in which to temporarily store data while it is processing the data.

Once a software module is completed processing the data, it passes the data to another software module for further processing. For example, an ATM driver may receive ATM cells from an interface connected an ATM network, process the cells, including, for example, reassembling the cells, and pass the reassembled cells, as a block of data to another software module, such as a Point to Point (PPP) software module. The PPP software module may receive the block of data, temporarily store the block of data in its own temporary buffer space while it processes the block of data, and then passes the block of data to another, higher layer protocol software module, such as an IP software module. The IP software module processes the block of data, and then, for example, passes it to the TCP software module, which, in turn, temporarily buffers the data in a buffer space allocated for the TCP software module.

Repeatedly copying a block of data from one buffer space utilized and accessible only to one protocol software module to another buffer space utilized and accessible only to another protocol software module is computationally expensive, and requires significant memory resources in a machine. Sharing the same buffer space between each of the protocol software modules reduces both the computation time required to read and write data from one buffer to another buffer, and reduces the memory required to process information exchanged between machines in a network.

### BRIEF DESCRIPTION OF THE DRAWINGS

The present invention is illustrated by way of example, and not necessarily by way of limitation in the figures of the accompanying drawings in which like reference numerals refer to similar elements.

FIG. 1 illustrates a block diagram of an embodiment of the present invention.

FIG. 2 illustrates a flow diagram of an embodiment of the present invention.

FIG. 3 illustrates a linked list of buffers as utilized by an embodiment of the present invention.

### DETAILED DESCRIPTION OF THE INVENTION

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description that follow are presented in terms of algorithms and symbolic representations of operations on data within a computer memory. These algorithmic descriptions and representations are the means used by those skilled in the data processing arts to most effectively convey the substance of their work to others skilled in the art.

An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated or otherwise apparent from the following discussion throughout the description, discussions using terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The invention also relates to apparatuses for performing the operations herein. These apparatuses may be specially constructed for the required purposes, or may comprise a general-purpose computer selectively activated or reconfigured by a computer program stored in the computer. Such a computer program may be stored in a machine-readable storage medium, such as, but not limited to, any type of magnetic or other disk storage media including floppy disks, optical storage media, CD-ROMs, and magnetic-optical disks, read-only memories (ROMs), random access memories (RAMs), EPROMs, EEPROMs, magnetic or optical cards, flash memory devices; electrical, optical, acoustical or other form of propagated signals (e.g., carrier waves, infrared signals, digital signals, etc.); etc. or any type of media suitable for storing electronic instructions, and each coupled to a computer system bus.

The algorithms presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

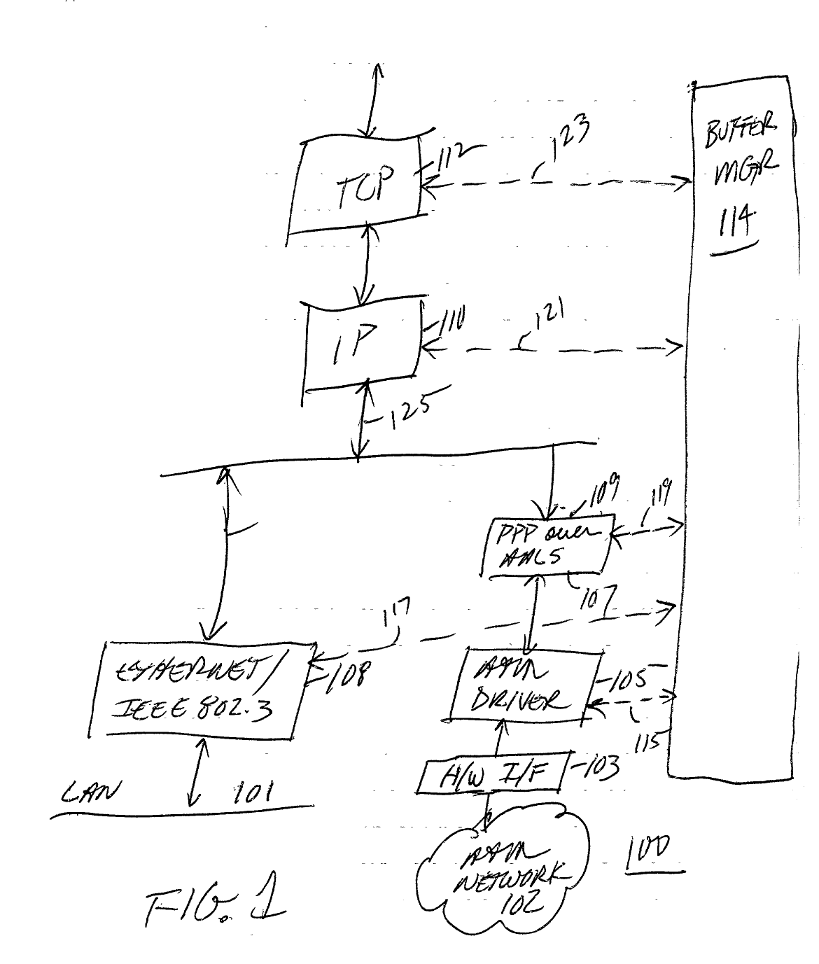

With reference to FIG. 1, a protocol stack as may be implemented in a machine 100 connected to a network, in accordance with the present invention, is illustrated. The machine 100 is connected, for example, to an ATM network 102. It is appreciated that the machine could be connected to other types of networks, such as a token ring network, a Frame Relay or X.25 network, an Ethernet, or Gigabit Ethernet network, without departing from the present invention. In one embodiment, the machine may be connected to multiple, homogeneous or heterogeneous, networks. For example, in FIG. 1, the machine is also coupled to Ethernet local area network 101 An Ethernet/IEEE 802.3Carrier Sense Multiple Access with Collision Detection (CSMA/CD) driver receives and transmits information in frames of data over local area network 101.

In any case, a hardware interface, typically implemented in a chipset, provides a physical connection to the network. A driver, such as ATM driver 105, transmits and receives information, generally in the form of a well defined stream of binary digits, respectively to and from the hardware interface 103. The driver provides a mechanism to transmit and receive the stream of binary digits as a block of data, whether defined as a fixed length cell, as in the case of an ATM stream of data, or a variable length frame of data, as in the case of an Ethernet-based frame of data transmitted over a local area network. An Ethernet/IEEE 802.3 hardware interface, not shown, provides a physical connection to local area network 101 and essentially operates in the same manner to generally perform the same functions as ATM hardware interface 103.

The ATM driver services higher layer protocol software modules in protocol stack implemented in the machine, such as PPP over ATM adaptation layer 5 (PPP over AAL5) software module 107 and Point to Point Protocol (PPP) software module 109. These modules, in turn, service, for example, a higher layer protocol software module such as IP software module 110. Likewise, the Ethernet driver services the IP software module 110. Finally, IP software module 110 services TCP software module 112.

In accordance with an embodiment of the present invention, each of the protocol software modules share the same buffer space in memory. In particular, when a frame or cell of data is received from a network attached to the machine, or when a packet of data is prepared for transmission over a network attached to the machine, as the data is processed by each appropriate protocol software module, the data is maintained in the same buffer space. Only the pointers to the data space need be passed between the protocol software modules so that the protocol software modules that process the data know where to access the data. This is advantageous in that it saves significant processing time over prior art implementations in which data is passed from a buffer space utilized by one protocol software module to another buffer space utilized by another protocol software module. Moreover, in the prior art, especially with the protocol software modules are developed by different vendors, the buffer formats and lengths are likely different so that it is problematic at times to move a packet of data from one buffer of one format to another buffer of another format.

In one embodiment of the present invention, a buffer manager software module 114 manages control of passing pointers to the shared buffer space to the protocol software modules so that a data frame can be accessed and processed as needed by each module without having copy the data frame from one buffer space to another buffer space.

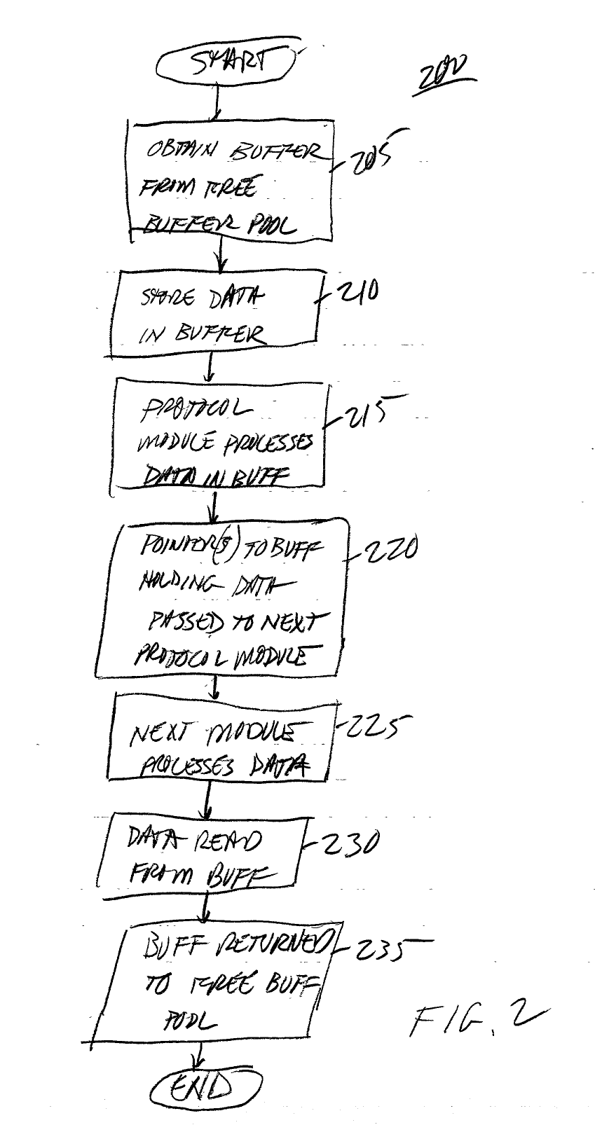

With reference to FIG. 2, an overview of the process embodied in the present invention is provided in a flow diagram. It should be noted that, for purposes of understanding the present invention, it is not important what, exactly, any particular protocol software module does in terms of inspecting, examining, manipulating, or otherwise processing a frame of data. Rather, it is important to understand how each protocol software module accesses the same frame of data in a shared buffer, and how such access obviates the need to copy the data frame to different buffers each accessed by different protocol software modules. Thus, the reader is referred to readily publicly available written documentation providing a description of the processes performed by a particular protocol. For example, the processes provided by the TCP/IP suite of protocols are documented in Internet Requests for Comments (RFCs) and numerous textbooks on the subject of internetworking and the Internet.

The process diagrammed in FIG. 2 contemplates receiving a data frame at a machine in which an embodiment of the present invention is implemented. (It will be appreciated that the process as described below is generally likewise applicable to the process involved in preparing a frame of data for transmission from a machine in which an embodiment f the present invention is implemented.) Typically, the data frame is received from a network or communications medium to which the machine is attached or via which the machine may communicate with other machines. As an initial step, a driver or physical layer protocol software module receives a frame of data. The data frame may comprise an Ethernet data frame, an ATM cell, or other type of data frame, depending on the one or more networks to which the machine is connected. The driver processes the data frame.

In particular, the driver may provide address detection on the data frame to see if the data frame is destined to the machine, and provide error control for the data within the frame, to ensure its integrity. Again, as mentioned above, it is not so much important what processing is performed by a particular software module on the frame of data as how the frame of data is stored in a buffer as it is processed by the particular protocol software module, and how that frame of data is accessed in that same buffer space by other protocol software modules.

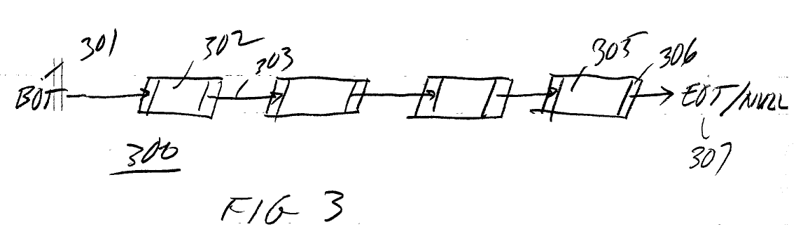

The data frame received must be stored temporarily in a buffer space in a memory of the machine as it is being processed. With reference to FIG. 3, the buffer manager 114 maintains a pool of available buffers from which a protocol module may select or be allocated a buffer for temporary storage of the frame of data. The pool of buffers may be maintained, for example, as a linked list of buffers, such as linked list 300. At 205, the buffer manager identifies a buffer of appropriate size in which to store the frame of data, and removes the buffer from the linked list of available buffers. In one embodiment, the buffer is located at the head of the linked list, such as buffer 301, pointed to by a beginning of table pointer 301. In other embodiments, the buffer is located at the tail of, or elsewhere within, the linked list, for example, buffer 305, which is at the end of the list as indicated by the fact that the pointer 306 in buffer 305 to the next buffer points to the end of the table, or has a null entry 307.

Having been allocated buffer 302, the driver protocol module stores the data frame in the buffer at 210, and processes as appropriate the frame of data at 215. When completed processing the data frame, control of processing the data frame is passed from the driver software module to the protocol software module it services. For example, the ATM driver software module passes control of processing the data frame to AAL5 protocol software module 107.

Rather than copying the data frame from the buffer 302 utilized by module 105 to another buffer accessed by module 107, an embodiment of the present invention, at 220, simply passes a pointer to the buffer 302 to module 107 so that module 107 can locate and access buffer 302 and continue to process the data frame as needed. Thus, for example, buffer manager 114 passes to PPP over AAL5 protocol software module 107 a pointer to buffer 302. In one embodiment, only a pointer to the data frame is passed to the next protocol software module that is to process further the data frame. In another embodiment, pointers to both the head and tail of the buffer is provided, and optionally, information such as the length of the buffer may also be passed by the buffer manager to the next appropriate software module. In FIG. 1, the dotted lines between buffer manager 114 and the various protocol software modules is representative of the communication of pointer information between software modules by the buffer manager.

At 225, the next module to which one or more pointers to the buffer in which the data frame is stored is passed, processes the data frame in accordance with the protocol adhered to by such next module. This process, of one protocol software module processing a data frame in a buffer, and the buffer manager passing pointers to a subsequent protocol software module for continued processing of the data frame, continues up the protocol stack until processing of the data frame by the machine is completed. At such time, the data is read from the buffer at 230 and, for example, provided to an application software program. At this point, for example, the buffer is no longer needed for temporarily storing the data packet while the various protocol software modules in the protocol stack process the data frame.

At 235, the buffer is returned to the linked list providing a free pool of buffers available for temporarily storing subsequent data frames received at or to be transmitted by the machine. In one embodiment, the buffer is returned to the end of the free buffers linked list by inserting the buffer prior to the null entry or end of table. In another embodiment, the buffer may be inserted at the beginning of or elsewhere in the linked list of free or available buffers.

The process of the present invention as described herein contemplates receiving at a machine connected to a network a frame of data transmitted over the network, and passing control of processing the frame of data up a protocol stack in the machine. It is appreciated that the process of the present invention is equally applicable to receiving at the top of the protocol stack a data frame from a higher layer application program, and passing control of processing the frame of data down the protocol stack in the machine in preparation for transmitting the data frame from the machine and over the attached network to another machine connected to the network. The process as described above operates in the same manner. However, it may be that, as lower layer protocol software modules in the protocol stack process the data frame and add their respective header information to the data frame, or otherwise encapsulate or provide protocol software module dependent information to the data frame, the existing buffer space allocated for storing the data frame as it is processed by the protocol stack may become insufficient. In such case, an additional buffer may need to be allocated and chained to the buffer already provided. This additional buffer would be allocated in the same manner as described above with respect to allocating the first buffer. The buffer manager then need only link the two buffers together and provide such information regarding the linking of the two buffers together to any subsequent protocol software module that processes the data frame stored in the multiple memory buffers.

What is claimed is:

1. A method for comprising:
receiving a data frame at a first communications protocol software module;
allocating a memory buffer in which to store at least some portion of the data frame from a pool of available memory buffers;
storing the at least some portion of the data frame in the memory buffer;
providing at least one pointer to the memory buffer to the first communications protocol software module, the first communications protocol software module accessing the at least some portion of the data frame in the memory buffer pointed to by the pointer to process the data frame;
transferring control of processing the data frame from the first communications protocol software module to a second communications protocol software module; and
providing the pointer to the memory buffer to the second communications protocol software module, the second communications protocol software module accessing the at least some portion of data frame in the memory buffer pointed to by the pointer to process the data frame.

2. The method of claim 1, wherein allocating a memory buffer in which to store the at least some portion of the data frame comprises allocating a memory buffer from a pool of available memory buffers in which to store the at least some portion of the data frame.

3. The method of claim 1, wherein providing at least one pointer to the memory buffer to the first communications protocol software module, the first communications protocol software module accessing the data frame in the memory buffer pointed to by the pointer to process the data frame, comprises providing a first pointer to a beginning of the memory buffer and a second pointer to an ending of the memory buffer.

4. The method of claim 3, further providing a length of the memory buffer to the first communications protocol module.

5. The method of claim 1, further comprising returning the memory buffer to the pool of available memory buffers when processing of the data frame is completed.

6. The method of claim 5, wherein returning the memory buffer to the pool of available memory buffers when processing of the data frame is completed, comprises inserting the pointer to the memory buffer in to a linked list of available memory buffers.

7. The method of claim 1, further comprising:
allocating a second memory buffer from a pool of available memory buffers in which to store at least some portion of the data frame, as needed for the communications protocol software module to process the data frame;
storing at least some portion of the data frame in the second memory buffer; and
providing at least one pointer to the second memory buffer to the communications protocol software module, the communications protocol software module accessing the at least some portion of the data frame in the memory buffer pointed to by the pointer to process the data frame.

8. A apparatus comprising:
means for receiving a data frame at a first communications protocol software module;
means for allocating a memory buffer in which to store at least some portion of the data frame from a pool of available memory buffers;
means for storing the at least some portion of the data frame in the memory buffer;
means for providing at least one pointer to the memory buffer to the first communications protocol software module, the first communications protocol software module accessing the at least some portion of the data frame in the memory buffer pointed to by the pointer to process the data frame;
means for transferring control of processing the data frame from the first communications protocol software module to a second communications protocol software module; and
means for providing the pointer to the memory buffer to the second communications protocol software module, the second communications protocol software module accessing the at least some portion of data frame in the memory buffer pointed to by the pointer to process the data frame.

9. The apparatus of claim 8, wherein the means for allocating a memory buffer in which to store the at least some portion of the data frame comprises means for allocating a memory buffer from a pool of available memory buffers in which to store the at least some portion of the data frame.

10. The apparatus of claim 8, wherein the means for providing at least one pointer to the memory buffer to the first communications protocol software module, the first communications protocol software module accessing the data frame in the memory buffer pointed to by the pointer to process the data frame, comprises means for providing a first pointer to a beginning of the memory buffer and a second pointer to an ending of the memory buffer.

11. The apparatus of claim 10, further providing a length of the memory buffer to the first communications protocol module.

12. The apparatus of claim 8, further comprising means for returning the memory buffer to the pool of available memory buffers when processing of the data frame is completed.

13. The apparatus of claim 12, wherein the means for returning the memory buffer to the pool of available memory buffers when processing of the data frame is completed, comprises means for inserting the pointer to the memory buffer in to a linked list of available memory buffers.

14. The apparatus of claim 8, further comprising:
means for allocating a second memory buffer from a pool of available memory buffers in which to store at least some portion of the data frame, as needed for the communications protocol software module to process the data frame;
means for storing at least some portion of the data frame in the second memory buffer; and
means for providing at least one pointer to the second memory buffer to the communications protocol software module, the communications protocol software module accessing the at least some portion of the data frame in the memory buffer pointed to by the pointer to process the data frame.

15. An article of manufacture, comprising:
a machine accessible medium, the machine accessible medium providing instructions, that when executed by a machine, cause the machine to:
receive a data frame at a first communications protocol software module; allocate a memory buffer in which to store at least some portion of the data frame from a pool of available memory buffers;
store the at least some portion of the data frame in the memory buffer; provide at least one pointer to the memory buffer to the first communications protocol software module, the first communications protocol software module accessing the at least some portion of the data frame in the memory buffer pointed to by the pointer to process the data frame;
transfer control of processing the data frame from the first communications protocol software module to a second communications protocol software module; and
provide the pointer to the memory buffer to the second communications protocol software module, the second communications protocol software module accessing the at least some portion of data frame in the memory buffer pointed to by the pointer to process the data frame.

16. The article of manufacture of claim 15, wherein the machine readable instructions, that when executed by a machine, cause the machine to allocate a memory buffer in which to store the at least some portion of the data frame, cause the machine to allocate a memory buffer from a pool of available memory buffers in which to store the at least some portion of the data frame.

17. The article of manufacture of claim 15, wherein the machine readable instructions, that when executed by a machine, cause the machine to provide at least one pointer to the memory buffer to the first communications protocol software module, the first communications protocol software module accessing the data frame in the memory buffer pointed to by the pointer to process the data frame, cause the machine to provide a first pointer to a beginning of the memory buffer and a second pointer to an ending of the memory buffer.

18. The article of manufacture of claim 17, further comprising machine readable instructions, that when executed by a machine, cause the machine to provide a length of the memory buffer to the first communications protocol module.

19. The article of manufacture of claim 15, further comprising machine readable instructions, that when executed by a machine, cause the machine to return the memory buffer to the pool of available memory buffers when processing of the data frame is completed.

20. The article of manufacture of claim 19, wherein the machine readable instructions, that when executed by a machine, cause the machine to return the memory buffer to the pool of available memory buffers when processing of the data frame is completed, cause the machine to insert the pointer to the memory buffer in to a linked list of available memory buffers.

21. The article of manufacture of claim 15, further comprising machine readable instructions, that when executed by a machine, cause the machine to:
allocate a second memory buffer from a pool of available memory buffers in which to store at least some portion of the data frame, as needed for the communications protocol software module to process the data frame;
store at least some portion of the data frame in the second memory buffer; and
provide at least one pointer to the second memory buffer to the communications protocol software module, the communications protocol software module accessing the at least some portion of the data frame in the memory buffer pointed to by the pointer to process the data frame.
